(19) United States
(12) Patent Application Publication
(10) Pub. No.: US 2017/0013308 A1
(43) Pub. Date: Jan. 12, 2017

(54) METHODS AND SYSTEMS FOR CONCURRENT PROGRAM VIEWING

(71) Applicant: The DIRECTV Group, Inc., El Segundo, CA (US)

(72) Inventor: Miguel A. Alvarez, San Pedro, CA (US)

(73) Assignee: The DIRECTV Group, Inc., El Segundo, CA (US)

(21) Appl. No.: 14/582,032

(22) Filed: Dec. 23, 2014

(51) Int. Cl. H04N 21/44; H04N 21/438; H04N 21/41; H04N 21/43

(52) U.S. Cl. CPC H04N 21/44; H04N 21/4302; H04N 21/438; H04N 21/4122; H04N 21/4126

(57) ABSTRACT

An example method may include receiving a first video transport stream comprising video content associated with a first program, and receiving a second video transport stream comprising video content associated with a second program. The method may also include generating a first video output signal based on the first video transport stream, where the first video output signal includes instructions to display content of the first video output signal via emitted light having a first polarization direction. The method may also include generating a second video output signal based on the second video transport stream, where the second video output signal is configured to be displayable on a graphic display simultaneously with the first video output signal, and where the second video output signal includes instructions to display content of the second video output signal via emitted light having a second polarization direction.

### BACKGROUND

Generally, a television broadcast system provides video, audio, and/or other data transport streams for each television program. A consumer system, such as a tuner, a receiver, or a set-top box, receives and processes the transport streams to provide appropriate video/audio/data outputs for a selected television program to a graphic device (e.g., a television, projector, laptop, tablet, smartphone, etc.). Traditionally, a single television program is viewed on a single graphic device at a given time. However, it may be advantageous to display multiple concurrent television programs on the same graphic display at the same time.

### SUMMARY

In one example, a method is disclosed that involves receiving a first video transport stream comprising video content associated with a first program. The method may also involve receiving a second video transport stream comprising video content associated with a second program. The method may also involve generating a first video output signal based on the first video transport stream, where the first video output signal is configured to be displayable on a graphic display, and where the first video output signal includes instructions to display content of the first video output signal via emitted light having a first polarization direction. The method may also involve generating a second video output signal based on the second video transport stream, where the second video output signal is configured to be displayable on the graphic display simultaneously with the first video output signal, and where the second video output signal includes instructions to display content of the second video output signal via emitted light having a second polarization direction.

In another example, a television broadcast system is disclosed. The television broadcast system may include a receiver configured to (i) receive a first video transport stream comprising video content associated with a first program, and (ii) receive a second video transport stream comprising video content associated with a second program. The television broadcast system may also include a video processing system configured to (i) generate a first video output signal based on the first video transport stream, wherein the first video output signal includes instructions to display content of the first video output signal via emitted light having a first polarization direction, and (ii) generate a second video output signal based on the second video transport stream, wherein the second video output signal includes instructions to display content of the second video output signal via emitted light having a second polarization direction. The television broadcast system may also include a display system configured to display the first video output signal and the second output signal simultaneously on a graphic display.

In another example, a non-transitory computer readable memory having stored therein instructions executable by a computing device to cause the computing device to perform functions is described. The functions may include receiving a second video transport stream comprising video content associated with a second program. The functions may also include generating a first video output signal based on the first video transport stream, where the first video output signal is configured to be displayable on a graphic display, and where the first video output signal includes instructions to display content of the first video output signal via emitted light having a first polarization direction. The functions may also include generating a second video output signal based on the second video transport stream, where the second video output signal is configured to be displayable on the graphic display simultaneously with the first video output signal, and where the second video output signal includes instructions to display content of the second video output signal via emitted light having a second polarization direction.

In yet another example, another method is disclosed that involves receiving a first video transport stream comprising video content associated with a first program. The method may also involve receiving a second video transport stream comprising video content associated with a second program. The method may also involve generating a first video output signal based on the first video transport stream, the first video output signal is configured to be displayable on a graphic display, and where the first video output signal includes instructions to display content of the first video output signal at a first periodicity. The method may also involve generating a second video output signal based on the second video transport stream, where the second video output signal is configured to be displayable on the graphic display, and where the second video output signal includes instructions to display content of the second video output signal at a second periodicity. The method may also involve providing for display the first video output signal and the second video output signal on the graphic display such that the graphic display alternates between displaying content of the first video output signal and content of the second video output signal based on the first periodicity and the second periodicity.

Also disclosed herein are structures configured to facilitate implementation of the disclosed methods. One embodiment may take the form of a computing device (e.g., a communication device, computing system, etcetera (etc.)) that includes a communication interface, a processor, data storage, and program instructions executable by the processor for carrying out the functions described herein. Another embodiment may take the form of a non-transitory computer-readable medium having instructions stored thereon for carrying out some or all of the functions described herein.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

Various embodiments are described herein with reference to the following drawings, in which like numerals denote like entities, and in which:

FIG. 1A is a simplified block diagram illustrating a communication system in which embodiments of the disclosed methods and entities can be implemented;

FIG. 1B is another simplified block diagram illustrating a communication system in which embodiments of the disclosed methods and entities can be implemented;

FIG. 2 is another simplified block diagram that illustrates a communication system in which embodiments of the disclosed methods and entities can be implemented;

FIG. 3 is a functional block diagram that illustrates a computing device used in a communication system;

FIG. 4 is a functional block diagram that illustrates a server used in a communication system;

FIG. 5 is a flow diagram that depicts functions that may be included in the communication system to facilitate implementation of the methods described herein;

FIG. 6 is another flow diagram that depicts functions that may be included in the communication system to facilitate implementation of the methods described herein;

FIG. 7A is a pictorial diagram that illustrates a user interface view according to an example embodiment;

FIG. 7B is another pictorial diagram that illustrates a user interface view according to an example embodiment; and

FIG. 8 is a pictorial diagram that illustrates an example system according to an example embodiment.

### DETAILED DESCRIPTION

In the following detailed description, reference is made to the accompanying figures, which form a part hereof. It should be understood, however, that the arrangements described herein are set forth as examples only. As such, those skilled in the art will appreciate that other arrangements and elements (e.g., machines, interfaces, functions, orders of functions, etc.) can be used instead or in addition. Further, many of the elements described herein are functional entities that may be implemented as discrete or distributed components or in conjunction with other components, and in any suitable combination and location. Various functions described herein as being performed by one or more entities may be carried out by hardware, firmware or software logic. For instance, various functions described herein may be carried out by a processor executing instructions written in any suitable programming language and stored in memory.

In this description, the articles “a” or “an” are used to introduce elements of the example embodiments. The intent of using those articles is that there is one or more of the elements. The intent of using the conjunction “or” within a described list of at least two terms is to indicate any of the listed terms or any combination of the listed terms. The use of ordinal numbers such as “first,” “second,” “third” and so on is to distinguish respective elements rather than to denote a particular order of those elements.

I. Overview

Example embodiments may help to provide television viewing options, for example, by allowing a first user to watch a first program on a graphic display while a second user watches a second program simultaneously on the same graphic display. Illustratively, a father may be able to select a sporting event to watch on the television, and a receiver may cause the television to display the sporting event via emitted light having a first polarization direction. At the same time, the father may select a cartoon show for his child to watch on the television, and the receiver may cause the television to simultaneously display the cartoon show via emitted light having a second polarization direction. The father may then wear a first pair of polarized glasses that are configured to block out light having the second polarization direction, and allow light having the first polarization to pass through. As such, the father will be able to view the sporting event and will not see the cartoon show. Similarly, the child may wear a second pair of polarized glasses that are configured to block out light having the first polarization direction, and allow light having the second polarization to pass through. The child will then be able to view the cartoon show and will not see the sporting event. The audio for each program may be directed to each user, for example via wireless headphones. In one embodiment, the wireless headphones may be integrated into the polarized glasses.

In another example, active shutter glasses may be used to achieve a similar result. In such a configuration, two programs are alternatively displayed on a television. Using the example described above, the television may rapidly alternate between showing a sporting event to be watched by a father and a cartoon show to be watched by a child. A first pair of active shutter glasses may be worn by the father that are configured to be transparent when the television displays the sporting event, and opaque when the television displays the cartoon show. The television alternates between the two programs rapidly, such that a user cannot detect any interruption in the viewing experience. As such, the father will be able to view the sporting event and will not see the cartoon show. Similarly, a second pair of active shutter glasses may be worn by the child that are configured to be transparent when the television displays the cartoon show, and opaque when the television displays the sporting event. As such, the child will then be able to view the cartoon show and will not see the sporting event. As discussed above, the audio for each program may be directed to each user.

Such a configuration may be useful in several situations. For example, a parent may wish to watch a program that has content of his interest, and kids may wish to watch content for their interests. Using the systems and methods described herein, a parent could watch such a program while their child simultaneously watches a second program more suited to their age level. As another example, such a configuration may be used on buses, trains and/or airplanes where a single television must be shared amongst multiple individuals so that all of the passengers are not required to watch the same program.

It should be understood that the above examples are provided for illustrative purposes, and should not be construed as limiting. As such, the method additionally or alternatively includes other steps or includes fewer steps, without departing from the scope of the invention.

II. Example Communication Systems

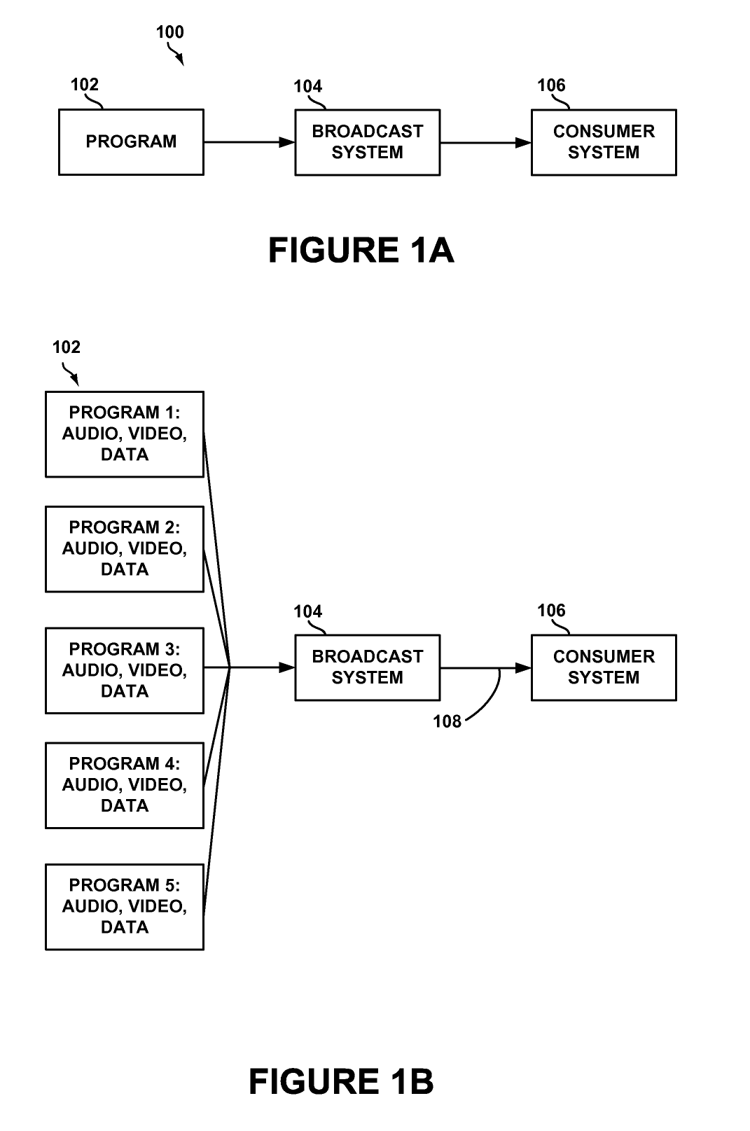

Referring now to the figures, FIG. 1A is a simplified block diagram that illustrates a communication system 100 in which embodiments of the disclosed methods and entities can be implemented. A program 102 may also be referred to as a television program or television show, and may include a segment of content that can be broadcast on a television channel. There are many types of programs 102, such as animated programs, comedy programs, drama programs, game show programs, sports programs, and informational programs. Programs 102 can be recorded and broadcast at a later date. Programs 102 may also be considered live television, or broadcast in real-time, as events happen in the present. Programs 102 may also be distributed, or streamed, over the Internet.

Programs 102 are generally provided to consumers by way of a broadcast system 104 and consumer system 106. There are many different types of broadcast systems 104, such as cable systems, fiber optic systems, satellite systems, and Internet systems. There are also a variety of consumer systems 106, including set-top box systems, integrated television tuner systems, and Internet-enabled systems. Other types of broadcast systems and/or consumer systems are also possible.

Turning now to FIG. 1B, the broadcast system 104 may be configured to receive video, audio, and/or data streams related to a program 102. The broadcast system 104 may also be configured to process the information from that program 102 into a transport stream 108. The transport stream 108 may include information related to more than one program 102 (but could also include information about just one program 102). The programs 102 are generally distributed from the broadcast system 104 as different television channels. A television channel may be a physical or virtual channel over which a particular program 102 is distributed and uniquely identified by the broadcast system 104 to the consumer system 106. For example, a television channel may be provided on a particular range of frequencies or wavelengths that are assigned to a particular television station. Additionally or alternatively, a television channel may be identified by one or more identifiers, such as call letters and/or a channel number.

In an example embodiment, a broadcast system 104 may transmit a transport stream 108 to the consumer system 106 in a reliable data format, such as the MPEG-2 transport stream. However, other formats for a transport stream are also possible. A transport stream 108 may specify a container format for encapsulating packetized streams (such as encoded audio or encoded video), which facilitates error correction and stream synchronization features that help to maintain transmission integrity when the signal is degraded.

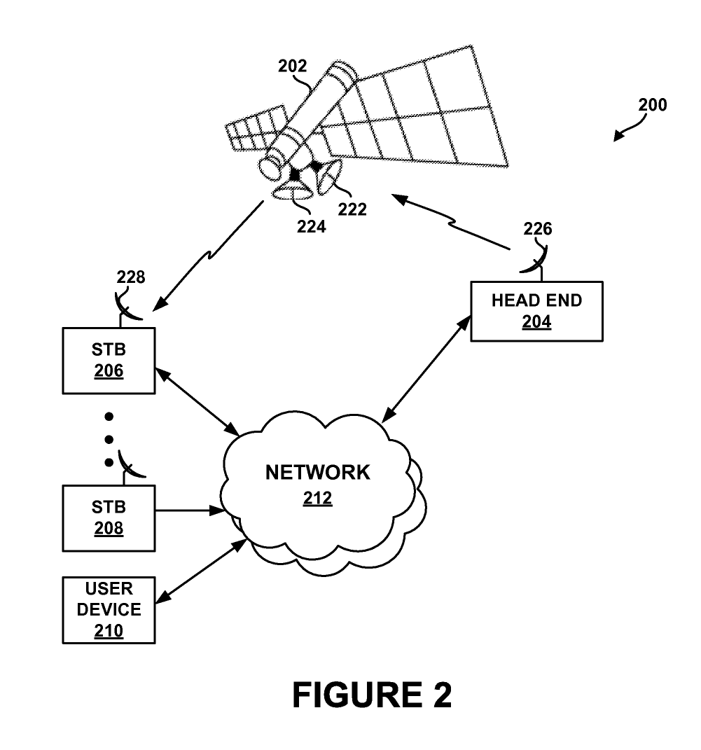

FIG. 2 is another simplified block diagram that illustrates a communication system 200 in which embodiments of the disclosed methods and entities can be implemented. In particular, the communication system 200 may include a satellite 202, a head end 204, one or more set-top boxes 206, 208, one or more user devices 210, and one or more networks 212. Other devices may also be included in the communication system 200. It should be understood that, although not illustrated, multiple satellites, head ends, servers, and other components might be included in the communication system 200. Moreover, while multiple components are illustrated separately, it should be understood that one or more of the components may be implemented as distributed components.

Satellite 202 may include one or more antennas 222, 224 configured to send and receive digital or analog signals to one or more devices in the communication system 200. For instance, satellite 202 may include a first antenna 222 configured to receive data via an uplink signal from a device, such as head end 204. Satellite 202 may also include a second antenna 224 that may transmit data via a downlink signal to a receiving device. The receiving device may be a mobile device or a stationary device. Set-top boxes 206, 208 or user device 210 may be a mobile device or a stationary device. In some examples, a single antenna may be used to receive data via an uplink signal and transmit data via a downlink signal. Other examples are also possible.

Head end 204 may include a transmitting antenna 226 for communicating data using one or more signals. For instance, transmitting antenna 226 may send signals to the antenna 222 at satellite 202. Satellite 202 may in turn send downlink signals to a receiving device, such as set-top box 206. In another instance, head end 204 may communicate data to set-top box 206 via a network 212. Network 212 may be representative of one or more types of networks, such as a public switched telephone network, the Internet, a mobile telephone network, or other type of network.

Set-top boxes 206, 208 are examples of receiving devices configured to receive data from satellite 202 or network 212. For example, set-top box 206 may include or be connected to an antenna 228 for receiving downlink signals from antenna 224. Set-top box 206 may also include one or more components structured and arranged to receive signals from network 212. The type, content, and number of signals received by set-top box 206 may vary. For instance, the signals may be media signals that may include video or audio signals. Data sent via the media signals may include content, program data, images, requests, or the like. Other examples are also possible.

In some examples, set-top boxes 206, 208 may be interconnected with one or more devices in the communication system 200 via a local network (not illustrated). The local network, which may be a wired network or wireless network, may be used to interconnect set-top boxes 206, 208 within a household, multi-dwelling unit, or commercial building. The local network may also allow for multi-room viewing of content stored on a first set-top box (such as set-top box 206) and communicated to a second set-top box (such as set-top box 208) through the local network. The stored content can comprise content a set-top box 206 receives from antenna 228.

User device 210 may include a variety of stationary or mobile computing devices. For example, user device 210 may include a landline telephone, cellular telephone, smartphone, personal computer, laptop computer, tablet computer, personal digital assistant (PDA), portable media player, or other computing device now known or later developed. User device 210 may be configured to send or receive data in a variety of ways. For example, user device 210 may receive downlink signals from antenna 224. In another example, user device 210 may send or receive signals from network 212. In yet another example, user device 210 may send or receive signals from one or more devices in the communication system 200. For instance, user device 210 may send or receive signals from set-top boxes 206, 208 via network 212. Other examples are also possible.

III. Example Computing Device

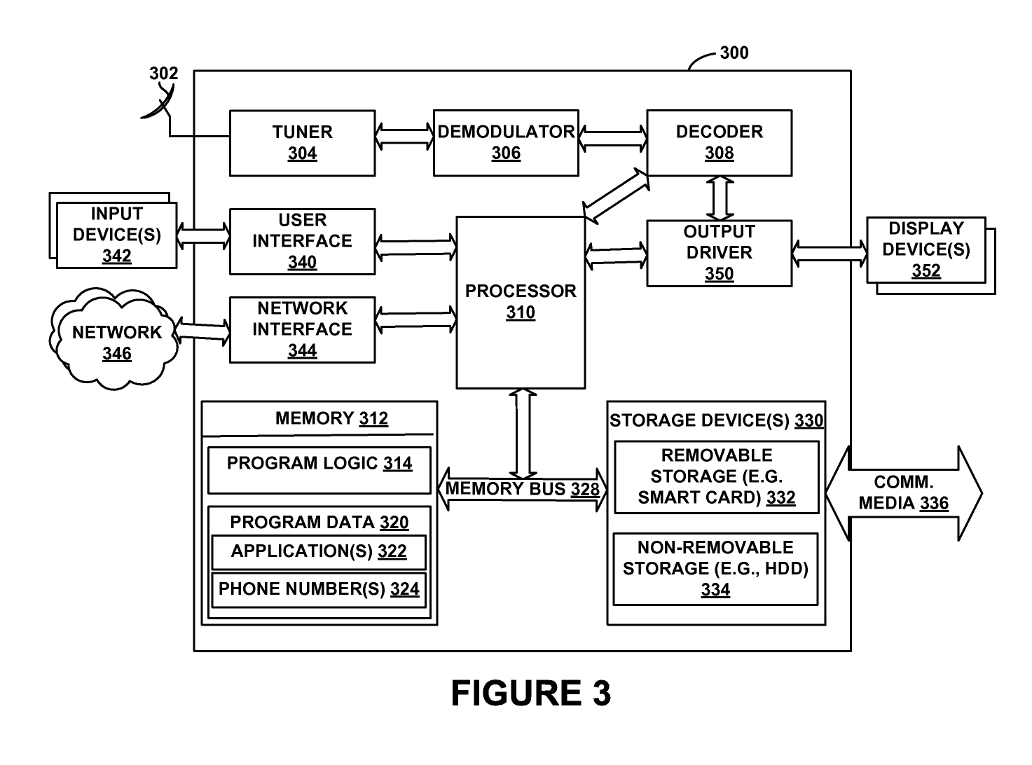

FIG. 3 is a functional block diagram that illustrates a computing device 300 used in a communication system in accordance with embodiments described herein. Computing device 300 may take a variety of forms. For example, computing device 300 may comprise or be arranged as a set-top box (such as set-top boxes 206, 208 of FIG. 2). The set-top box may be used for television or other media. As another example, computing device 300 may comprise or be arranged as a landline or cellular telephone, smartphone, personal computer, laptop computer, tablet computer, personal digital assistant (PDA), portable media player, or other computing device now known or later developed.

Computing device 300 may include an antenna 302, a tuner 304, a demodulator 306, a decoder 308, a processor 310, a memory 312, one or more storage devices 330, a user interface 340, a network interface 344, and an output driver 350. Although, a particular configuration of computing device 300 is illustrated, the configuration is merely representative of various possible receiving devices. For example, although only one tuner 304, one demodulator 306, and one decoder 308 are illustrated, multiple tuners, demodulators, or decoders may be provided within computing device 300. The components described in FIG. 3 may be communicatively linked by a system bus, network, or other connection mechanism.

Antenna 302 may be one of a number of different types of antennas that may include one or more low noise blocks downconverters (LNB) associated therewith. For instance, antenna 302 may be a single antenna for receiving signals from a satellite (such as satellite 202 of FIG. 2), network (such as network 212 of FIG. 2), or terrestrial source. In another instance, antenna 302 may include multiple antennas for different orbital slots. In yet another instance, signals and other items described as being received by antenna 302 can be received by network interface 344 by way of a coaxial cable or other communication link. In that regard, one or more signals or items received at network interface 344 can be forwarded to tuner 304.

Tuner 304 may receive a signal from antenna 302. The signal may be a media signal that may include video or audio signals. The signal may also include a television signal. The content of the signal may vary based on the type of signal. For example, the content may include television programming content, program guide data or other types of data. Tuner 304 may communicate the signal to demodulator 306.

Demodulator 306 may receive the signal and demodulate the signal to form a demodulated signal. Decoder 308 may decode the demodulated signal to form a decoded signal or decoded data. The decoded signal may be sent to processor 310 or output driver 350. However, other examples are also possible.

Processor 310 may be any type of processor, such as a microprocessor, a microcontroller, a digital signal processor (DSP), multicore processor, etc. Processor 310 may be used to coordinate or control tuner 304, demodulator 306, decoder 308, and any other components of computing device 300 that may or may not be illustrated in FIG. 3. In some implementations, processor 310 may include an internal memory controller (not illustrated). Yet other implementations may include a separate memory controller that can be used with processor 310.

A memory bus 328 can be used for communicating between the processor 310 and memory 312. Memory 312 may be any suitable type of memory. For example, memory 312 may include a non-transitory computer-readable medium, for example, such as computer-readable media that stores data for short periods of time like solid-state memory, flash drives, register memory, processor cache and Random Access Memory (RAM). The computer-readable medium may also or alternatively include non-transitory media, such as secondary or persistent long-term storage, like read only memory (ROM), optical or magnetic disks, compact disc read only memory (CD-ROM), for example. The computer-readable medium may also be any other volatile or non-volatile storage system. The computer-readable medium may, for example, be considered a computer-readable storage medium or a tangible storage device.

Memory 312 may include program logic 314 and program data 320. Program logic 314 may include programming instructions, such as computer executable or logic-implemented instructions. In some examples, the programming instructions may be provided or otherwise obtainable in a downloadable format, such as via network 346 (which may be illustrated as network 212 in FIG. 2). Program data 320 may include program information that can be directed to various data types. For instance, program data 320 may include one or more applications 322 that may execute one or more algorithms arranged to provide input components of computing device 300, in accordance with the present disclosure. Program data 320 may also include data that may be stored in memory 312 at computing device 300.

In some implementations, memory 312 may be distributed between one or more locations. For example, at least a portion of memory 312 may reside within processor 310. In another example, all or part of memory 312 may reside on a storage device 330. Storage device 330 may include removable storage devices, non-removable storage devices, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), memory cards, smart cards and tape drives to name a few. Computer storage media can include volatile and nonvolatile, transitory, non-transitory, removable and non-removable media implemented in any method or technology for storage of information, such as computer-readable instructions, data structures, program modules, or other data.

Computing device 300 may also include a user interface 340 that is configured to allow a user to interact with computing device 300 via one or more input devices 342. Examples of input device 342 may include a remote control (or more simply, a remote), keyboard, a computer mouse, one or more push buttons, a touch screen, a smart phone, a tablet PC, a voice activated interface, or the like. Input device 342 may be used, for example, to select a channel, select information, change the volume, change the display appearance, or other functions using user interface 340. The process of making a selection with input device 342 may take a variety of forms, such as an action by a user.

Computing device 300 may include network interface 344 for communicating data through one or more networks 346. Network interface 344 may take a variety of forms. For example, network interface 344 may be a WiFi, WiMax, WiMax mobile, data over cable service interface specification (DOC SIS), wireless, cellular, or other types of interfaces. Moreover, network interface 344 may use a variety of protocols for communicating via the network 346. For instance, network interface 344 may communicate using Ethernet, a Transmission Control Protocol/Internet Protocol (TCP/IP), a hypertext transfer protocol (HTTP), or some other protocol.

Computing device 300 may be coupled to a display 352. Display 352 may be a television, monitor, or other device configured to display images. The images may be video, graphics, text, or any variety of other visual representations. In some examples, the display 352 may include an audio output, such as a loudspeaker, to generate sound waves from media signals received by display 352.

Display 352 may communicate with an output driver 350 within computing device 300 to facilitate communication between computing device 300 and display 352. In some implementations, output driver 350 may work in conjunction with a graphics processing unit (not illustrated), which can be configured to communicate with display device 352. Output driver 350 can communicate with display device 352 by a high-definition multiple interface (HDMI) cable, a coaxial cable, some other wired communication link, or wirelessly.

In some examples, computing device 300 may communicate directly or indirectly with one or more additional devices using a communication media 336. A communication connection is one example of a communication media 336. Communication media 336 may be embodied by computer-readable instructions, data structures, program modules, or other data in a modulated data signal, such as a carrier wave or other transport mechanism. The communication media 336 may also include wireless, optical, or other information delivery media. A modulated data signal can be a signal that has one or more of its characteristics set or changed in such a manner to encode information in the signal. By way of example, and not limitation, communication media 336 can include wired media such as a wired network or direct-wired connection, and wireless media such as acoustic, radio frequency (RF), infrared (IR) or other wireless media. The communication may include a cellular or cellular data connection, a satellite data connection, etc.

IV. Example Server

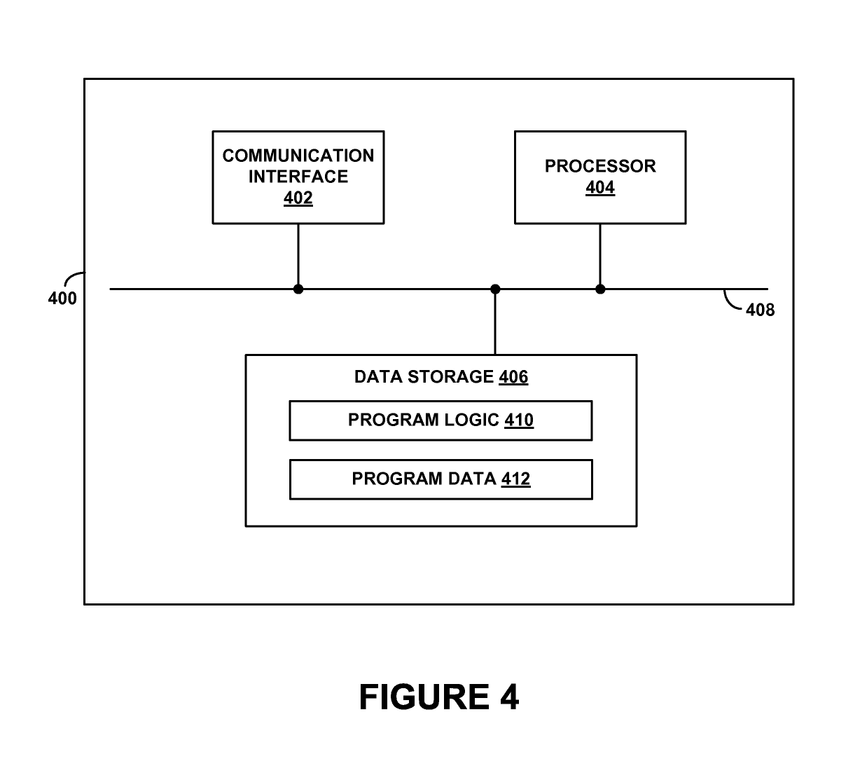

FIG. 4 is a functional block diagram that illustrates a server 400 used in a communication system in accordance with embodiments described herein. As shown, server 400 may include a communication interface 402, a processor 404, and a data storage 406, all of which may be communicatively linked together by a system bus, network, or one or more other connection mechanisms 408. Although not shown, server 400 may also include other components, such as external storage. It should also be understood that the configuration or functionality of server 400 may be distributed or subdivided between a plurality of entities, such as multiple servers. Further, it should be understood that some of the functions described herein may be carried out by an entity other than a server.

In server 400, the communication interface 402 may comprise one or more structures, and associated equipment, for receiving data from one or more sources and distributing data to a group of one or more destinations. For instance, communication interface 402 may be configured to receive a request from one or more entities (such as a set-top box) and add the request in a queue based on data associated with the request. The communication interface 402 may also be configured to provide for a communication to occur once the request is dequeued or otherwise processed.

Processor 404 may comprise one or more processors, such as general-purpose processors (e.g., a microprocessor), special-purpose processors (e.g., an application-specific integrated circuit (ASIC) or digital-signal processor (DSP)), programmable-logic devices (e.g., a field programmable gate array (FPGA)), or any other processor components now known or later developed. Processor 404 may be integrated in whole or in part with other components of server 300

Data storage 406 may be a non-transitory computer-readable medium. For example, data storage 406 may take the form of one or more volatile or non-volatile storage components, such as magnetic, optical, or organic storage components, integrated in whole or in part with a processor 406. As further shown, data storage 406 may include program logic 410 or program data 412. Program logic 410 may include, for example, machine language instructions executable by processor 404 to carry out various functions, such as the functionality of the methods and systems described herein. Program data 412 may include one or more types of data deemed suitable for a given implementation. For example, program data 412 may include program information that can be directed to various data types (such as queues). Program data 412 may also include data that may be stored in memory.

V. End User Methods and Examples

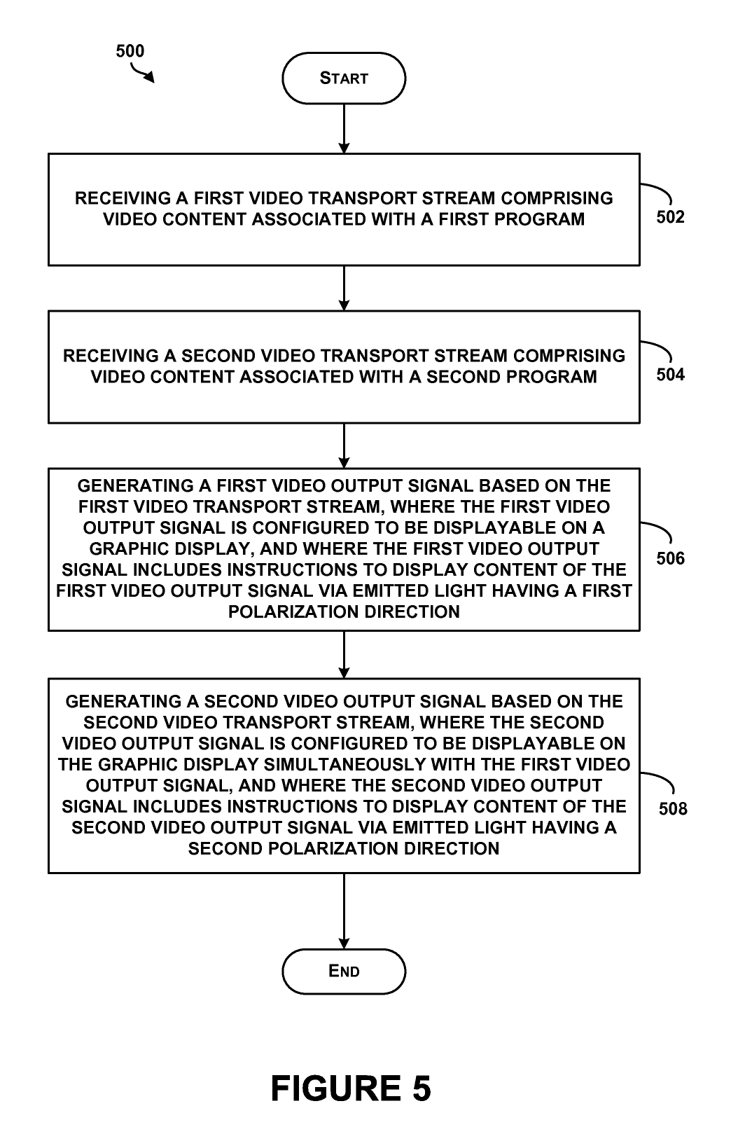

FIG. 5 is a flow diagram 500 that depicts functions that may be included in or performed by the communication system to facilitate implementation of the methods described herein. The methods may be used with a communication system (such as communication system 100 in Figures lA and 1B, or communication system 200 in FIG. 2), and may be performed by a device or components of one or more devices.

For purposes of illustration, the method in FIG. 5 is described as being implemented by a computing device (such as set-top box 206 in FIG. 2 or computing device 300 in FIG. 3), however, other examples are also possible. The computing device may be configured to receive one or more media signals. The media signals may include video, audio, or television signals.

At block 502, the computing device may receive a first video transport stream comprising video content associated with a first program. Similarly, at block 504, the computing device may receive a second video transport stream comprising video content associated with a second program. The first and second programs may be television programs, such as animated programs, comedy programs, drama programs, game show programs, sports programs, and informational programs. The first program and/or second program may be broadcast in real-time, or may be a recorded program that is broadcast at a later date.

At block 506, the computing device may generate a first video output signal based on the first video transport stream. In one example, upon receipt of the first video transport stream, a rendering module of the computing device may process the video content in the first video transport stream to generate the first video output signal. Additionally or alternatively, the computing device may receive and process the first video transport stream using different components or methods. For example, the computing device may include a separate video processing system or component to receive the first video transport stream, and/or to generate the first video output signal.

Once the first video transport stream has been processed by the computing device, the resulting first video output signal may be configured to be displayable on a graphic display, such as a television, monitor, projector, or other device configured to display images. In addition, the first video output signal may include instructions to display the content of the first video output signal via emitted light having a first polarization direction. In one example, the first video output stream may include such instructions in a data packet header. In another example, the first video output stream may include metadata providing such instructions. Other examples are possible as well.

In one example, the instructions to display the content of the first video output signal via emitted light having a first polarization direction may be received by the graphic display. The graphic display may responsively pass emitted light corresponding to the first video output signal through a polarizing filter such that the emitted light is linearly polarized. A user may be able to view the first program by wearing a first pair of polarized glasses which also contain a polarizing filter oriented the same direction as the polarizing filter of the graphic display. In another example, in response to receiving the instructions to display the content of the first video output signal via emitted light having a first polarization direction, the graphic display may pass emitted light corresponding to the first video output signal through a linear polarizer and a quarter-wave plate. The resulting emitted light is circularly polarized. Based on the arrangement of the linear polarizer and quarter-wave plate, the circularly polarized light may be either “right-handed” or “left-handed.” As such, a user may be a17ble to view the first program by wearing a pair of polarized glasses having appropriate analyzing filters. The analyzing filters are circular polarizers mounted in reverse, including a quarter-wave plate and a linear polarizer. Light that is left-circularly polarized is blocked by a right-handed analyzer, while right-circularly polarized light is blocked by the left-handed analyzer. Other examples are possible as well.

At block 508, the computing device may generate a second video output signal based on the second video transport stream. The second video output signal may be configured to be displayable on the graphic display simultaneously with the first video output signal. Further, the second video output signal may include instructions to display the content of the second video output signal via emitted light having a second polarization direction. In one example, the second video output stream may include such instructions in a data packet header, or the second video output stream may include metadata providing such instructions. Other examples are possible as well. The polarization direction may be applied to the second video output signal using any of the embodiments described above. In one example, the second polarization direction is perpendicular to the first polarization direction. For example, the first polarization direction may be right-handed circular polarization, while the second polarization direction may be left-handed circular polarization. As another example, the first polarization direction may be linear polarized at 45 degrees, while the second polarization direction may be linear polarized light at 135 decrees. Other examples are possible as well.

The computing device may be configured to generate the first video output signal and second video output signal based on input from user via user interface. For example, a user may select the software application “mulitviewing” in a menu on the graphic display. Once selected, the “multiviewing” application may be launched and the user may be presented with a first media signal displayable to present an option to select a first program for multiviewing. The user may select the first program, and the computing device may responsively generate the first video output signal. Subsequently, the user may be presented with a second media signal displayable to present an option to select a second program for multiviewing. The user may select the second program, and the computing device may responsively generate the second video output signal. Other examples are possible as well.

The method may further include the computing device providing for display the first video output signal and the second video output signal simultaneously on the graphic display. As such, a first user may be able to watch the first program on the graphic display using one pair of polarized glasses, while a second user may be able to simultaneously watch the second program on the graphic display using another pair of polarized glasses.

In one embodiment, the computing device may further receive a first audio transport stream comprising audio content associated with the first program, and a second audio transport stream comprising audio content associated with the second program. The computing device may then transmit the first audio transport stream to a first device via a communication link. The communication link may be wired, or a wireless connection. For example, the communication link may be a wired serial bus such as a universal serial bus or a parallel bus. A wired connection may be a proprietary connection as well. The communication link may also be a wireless communication interface using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities.

Similarly, the computing device may transmit the second audio transport stream to a second device via a communication link. The first device and second device may take many forms. For example, the first device and/or second device may be a pair of wired headphones, a pair of wireless headphones, or a pair of polarized glasses with built in headphones. In another example, the first device and/or second device may be an intermediate device (such as a mobile phone) that is in further communication with a pair of wired headphones, a pair of wireless headphones, or a pair of polarized glasses with built in headphones. In one example, the communication link between the second device and the computing device may be the same as the communication link between the first device and the computing device. In another example, the communication link between the second device and the computing device may be different the communication link between the first device and the computing device. For example, the computing device may transmit the first audio transport stream to the first device via a Bluetooth® wireless connection, but the computing device may use a wired connect to transmit the second audio transport stream to the second device. Other examples are possible as well.

In another embodiment, the computing device may receive a third video transport stream comprising video content associated with a third program. In such an embodiment, the method may further include the computing device generating a third video output signal based on the third video transport stream. The third video output signal may be configured to be displayable on the graphic display simultaneously with the first video output signal and the second video output signal. Further, the third video output signal may include instructions to display content of the third video output signal via emitted light having a third polarization direction. The computing device may then provide for display the first video signal, the second video output signal, and the third video output signal simultaneously on the graphic display.

In addition, the computing device may receive a third audio transport stream comprising audio content associated with the third program. The computing device may then transmit the third audio transport stream to a first device via a communication link, as discussed above. As such, three users may be able to watch and listen to three different programs on a graphic display simultaneously. Additional programs are possible as well.

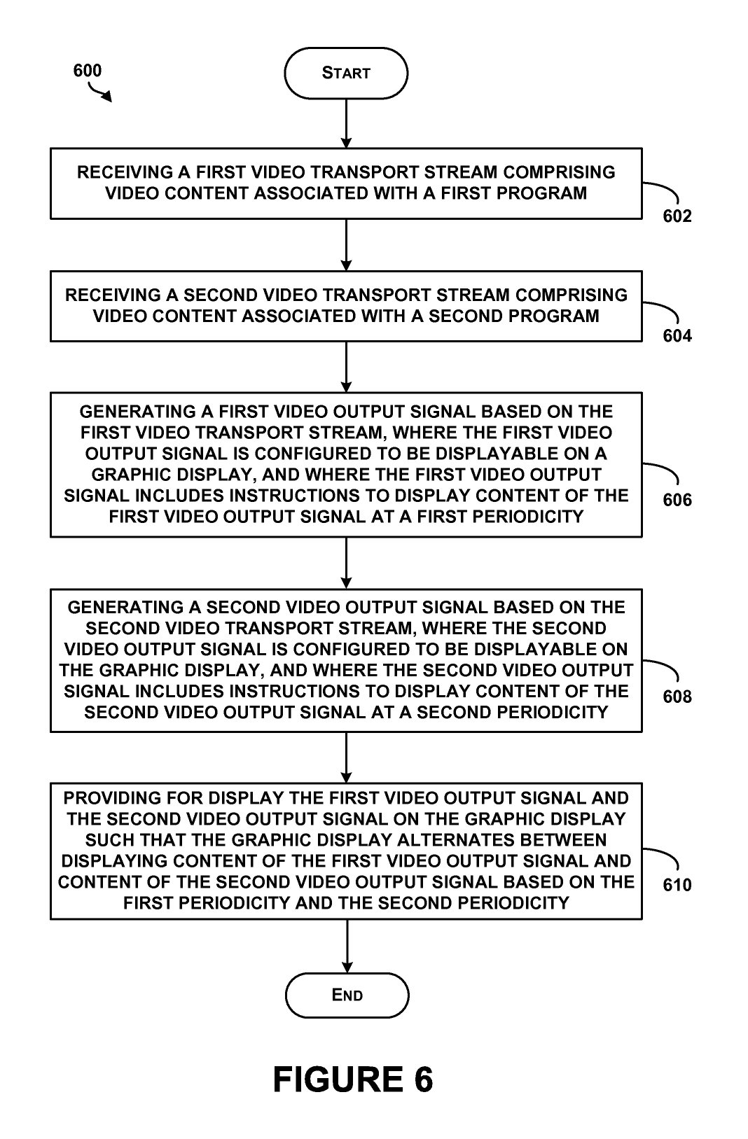

FIG. 6 is another flow diagram 600 that depicts functions that may be included in or performed by the communication system to facilitate implementation of the methods described herein. In particular, the method described in FIG. 6 is a time-multiplexed solution utilizing shuttered selection of interlaced frames. The methods may be used with a communication system (such as communication system 100 in FIGS. 1A and 1B, or communication system 200 in FIG. 2), and may be performed by a device or components of one or more devices.

In particular, at block 602, the computing device may receive a first video transport stream comprising video content associated with a first program. Similarly, at block 604, the computing device may receive a second video transport stream comprising video content associated with a second program. The first and second programs may be television programs, such as animated programs, comedy programs, drama programs, game show programs, sports programs, and informational programs, as discussed above. The first program and/or second program may be broadcast in real-time, or may be a recorded program that is broadcast at a later date.

At block 606, the computing device may generate a first video output signal based on the first video transport stream. In one example, upon receipt of the first video transport stream, a rendering module of the computing device may process the video content in the first video transport stream to generate the first video output signal. Additionally or alternatively, the computing device may receive and process the first video transport stream using different components or methods. For example, the computing device may include a separate video processing system or component to receive the first video transport stream, and/or to generate the first video output signal.

Once the first video transport stream has been processed by the computing device, the resulting first video output signal may be configured to be displayable on a graphic display, such as a television, monitor, projector, or other device configured to display images. In addition, the first video output signal may include instructions to display the content of the first video output signal at a first periodicity. The first periodicity causes the graphic display to display content of the first video output signal intermittently with a given interval between each frame. For example, the first periodicity may represent a number of times per second content of the first video display is displayed on the graphic display. As a specific example, the first periodicity may cause the graphic display to display content of the first video output signal 20 times per second, with a time period of 50 milliseconds between each displayed frame of the content of the first video display. In one example, the first video output stream may include such instructions in a data packet header. In another example, the first video output stream may include metadata providing such instructions. Other examples are possible as well.

At block 608, the computing device may generate a second video output signal based on the second video transport stream. The second video output signal may be configured to be displayable on the graphic display. Further, the second video output signal may include instructions to display the content of the second video output signal at a second periodicity. Similar to the first periodicity discussed above, the second periodicity causes the graphic display to display content of the second video output signal intermittently with a given interval between each frame. As such, the second periodicity may represent a number of times per second content of the second video display is displayed on the graphic display. Using the example described above, the second periodicity may cause the graphic display to display content of the second video output signal 20 times per second, with a time period of 50 milliseconds between each displayed frame of the content of the first video display. Further, the second periodicity may be offset from the first periodicity such that the graphic display alternates between displaying content of the first video output signal and content of the second video output signal. For example, the second periodicity may be offset from the first periodicity by 50 milliseconds. In one example, the second video output stream may include such instructions in a data packet header, or the second video output stream may include metadata providing such instructions. Other examples are possible as well.

At block 610, the computing device may provide for display the first video output signal and the second video output signal on the graphic display such that the graphic display alternates between displaying content of the first video output signal and content of the second video output signal based on the first periodicity and the second periodicity. In one example, the first periodicity and the second periodicity may be based on a refresh rate of the graphic display. For example, if the graphic display has a refresh rate of 60 Hertz, the first periodicity and second periodicity may cause the computing device to alternate between displaying content of the first video output signal and content of the second video output signal, such that each are displayed 30 times per second. As another example, if the graphic display has a refresh rate of 120 Hertz, the first periodicity and second periodicity may cause the computing device to alternate between displaying content of the first video output signal and content of the second video output signal, such that each are displayed 60 times per second.

In one embodiment, the computing device may further receive a first audio transport stream comprising audio content associated with the first program, and a second audio transport stream comprising audio content associated with the second program. The computing device may then transmit the first audio transport stream to a first device via a communication link. The communication link may be wired, or a wireless connection, as discussed above. Similarly, the computing device may transmit the second audio transport stream to a second device via a communication link. The first device and second device may take many forms. For example, the first device and/or second device may be a pair of wired headphones, a pair of wireless headphones, or a pair of active shutter glasses with built in headphones. In another example, the first device and/or second device may be an intermediate device (such as a mobile phone) that is in further communication with a pair of wired headphones, a pair of wireless headphones, or a pair of active shutter glasses with built in headphones. Other examples are possible as well.

In a particular example, the computing device may transmit a first audio transport stream comprising audio content associated with the first program to one or more headphones of a first pair of active shutter glasses. The first pair of active shutter glasses may be configured to synchronize with the first periodicity such that the first pair of active shutter glasses are transparent when the graphic display displays content of the first video output signal, and are opaque when the graphic display displays content of the second video output signal. Each lens of the first pair of active shutter glasses contains a liquid crystal layer which has the property of becoming opaque when voltage is applied, being otherwise transparent. The first pair of active shutter glasses is controlled by a first timing signal that allows the glasses to alternately block the vision of the user or allow light to pass through, in synchronization with the first periodicity. As such, a user will only be able to view the first program when wearing the first pair of active shutter glasses. The timing synchronization to the first periodicity of the first video output signal may be achieved via a wired signal, or wirelessly by either an infrared or radio frequency transmitter.

Further, the computing device may transmit a second audio transport stream comprising audio content associated with the second program to one or more headphones of a second pair of active shutter glasses. The second pair of active shutter glasses may be configured to synchronize with the second periodicity such that the second pair of active shutter glasses are transparent when the graphic display displays content of the second video output signal, and opaque when the graphic display displays content of the first video output signal. The second pair of active shutter glasses is controlled by a second timing signal that allows the glasses to alternately block the vision of the user or allow light to pass through, in synchronization with the second periodicity. As such, a user will only be able to view the second program when wearing the second pair of active shutter glasses. The timing synchronization to the second periodicity of the second video output signal may be achieved via a wired signal, or wirelessly by either an infrared or radio frequency transmitter.

In another embodiment, the computing device may receive a third video transport stream comprising video content associated with a third program. In such an embodiment, the method may further include the computing device generating a third video output signal based on the third video transport stream. The third video output signal may be configured to be displayable on the graphic display in addition to the first video output signal and the second video output signal. Further, the third video output signal may include instructions to display content of the third video output signal at a third periodicity. The computing device may then provide for display the first video signal, the second video output signal, and the third video output signal on the graphic display such that the graphic display alternates between displaying content of the first video output signal, content of the second video output signal, and content of the third video output signal based on the first periodicity, the second periodicity, and the third periodicity.

In addition, the computing device may receive a third audio transport stream comprising audio content associated with the third program. The computing device may then transmit the third audio transport stream to a first device via a communication link, as discussed above. As such, users may be able to watch and listen to three different programs on a graphic display simultaneously. Syncing a user's active shutter glasses to one of a plurality of available interlaced frame slots (e.g., video output signals) would permit a greater number of concurrent programs to be displayed (subject to flicker degradation from respective reduction in frame rates of the video output signals). As such, additional programs (e.g., more than three programs) may be displayed on the graphic display and synced with the active shutter glasses to provide additional viewing options for users.

As discussed above, the methods described herein may be useful in a variety of situations. For example, two individuals may wish to watch two different programs on the same television. Using the systems and methods described herein, a parent could watch such a first program while their child simultaneously watches a second program. As another example, such a configuration may be used in a bar such that patrons could watch multiple different programs on the same graphic display.

As yet another example, such a configuration may be used on buses, trains and/or airplanes where a single television must be shared amongst multiple individuals so that all of the passengers are not required to watch the same program. In such an example, each user may tune to a given audio channel, and a pair of active shutter glasses may be synchronized with an appropriate periodicity for one of several programs displayed on the shared cabin display screen corresponding to the given audio channel. To allow for all passengers to see a joint presentation (e.g., a flight safety video), a computing device could patch the presentation into all of the frame timeslots and/or replace a subset of the timeslots with black frames. As another example, a user may be given a pair of polarized glasses that correspond to the polarity of emitted light for a given program displayed on the shared cabin display screen. In one example, glasses may be available for a purchase from the travel provider.

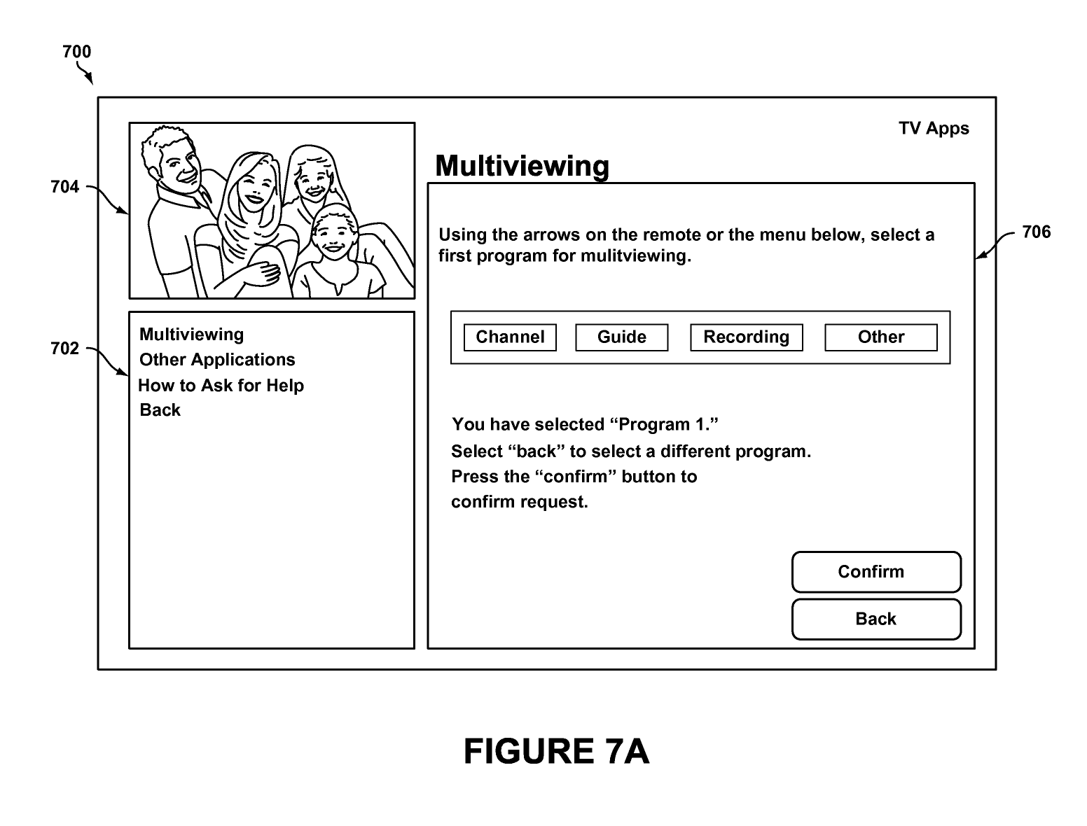

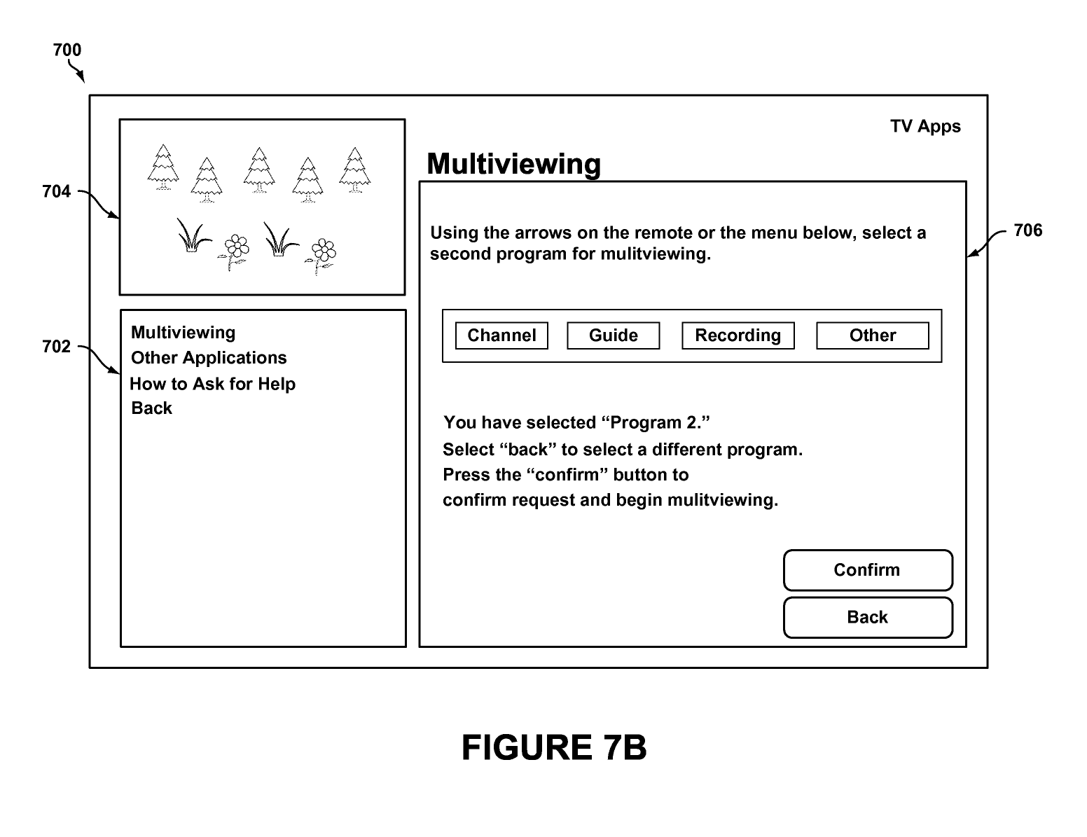

FIGS. 7A and 7B are pictorial diagrams illustrating an example user interface views transmitted within a media signal to display device 352 by output driver 350. Each user interface view can include a portion for displaying a media signal (from decoder 308), a menu portion, etc. The media signal may include a video signal, audio signal, or a television signal.

The FIGS. 7A and 7B are described in the context of a user interacting with a software application (such as application 322 in FIG. 3) at the computing device. The application may be installed at the computing device and executable to provide outputs in the form of one or more media signals that are displayable to the user via a display device (such as display device 352 in FIG. 3). If the application is not installed at the computing device, the computing device may request the application from a server (such as server 400 in FIG. 4). The server may send all or part of the application to the computing device over a network (such as network 212 in FIG. 2). The server may also send application updates or modifications to the computing device via the network. In some instances, the computing device may request the application from the server in response to a customer request to use the application.

FIG. 7A is a pictorial diagram that illustrates a user interface view 700 of data associated with an application in accordance with embodiments described herein. As illustrated, user interface view 700 includes a menu 702, a first display portion 704 generated from a television signal, and a second display portion 706 generated from a media signal. The television signal for generating the first display portion can be included within or separate from the media signal used to generate the second display portion. In another embodiment, the user interface view 700 may only include the menu 702 and the second display portion 706. In yet another embodiment, the user interface view 700 may only include the second display portion 706.

The menu 702, first display portion 704, or second display portion 706 may be static or dynamic (e.g., changing). For example, the menu 702 and second display portion 706 can be dynamic in that movement of an indicator, such as a pointer, can highlight or otherwise identify selectable inputs. In another example, the first display portion 704 can be a dynamic television signal or a static television signal (e.g., if the first display portion 704 is stopped or paused). If the television signal received for first portion 704 is not paused or stopped, first portion 704 can show a changing television program while menu 702 and second portion 706 can be static if no selection is made. A dynamic first display portion 704 may allow a user to continue to watch a television program that the user may have been watching prior to requesting the application by continuing to display signals received or otherwise stored and output by the computing device. In some instances, the user may also change the channel (tune to another channel) while the “multiviewing” application is displayed to the user.

A user may interact with menu 702, first display portion 704, or second display portion 706, to input or receive data. For example, a user may select the software application “mulitviewing” in menu 702. Once selected, the “multiviewing” application may be launched and the user may be presented with a first media signal displayable to present an option to select a first program for multiviewing. The user may select the first program in a number of ways. For example, the user may select the first program by entering a channel number corresponding to a given program. As another example, the user may select “guide” to proceed to view a guide of all available programs. As yet another example, the user may select “recordings” to view all programs recorded and stored in the data storage of the computing device. Other examples are possible as well. In one embodiment, the first display portion 704 may provide a visual preview of the selected first program. After selecting a first program, the second display portion 706 may display the selected first program, and the user may select “confirm” to proceed to another interactive view or display.

FIG. 7B is a pictorial diagram that illustrates a user interface view 700 for selecting a second program for multiviewing. As illustrated, the user may be presented with a second media signal displayable to present an option to select a second program for multiviewing. The user may select the first program in a number of ways, as described above. In one embodiment, the first display portion 704 may provide a visual preview of the selected second program. Once the user selects the second program, the second display portion 706 may display the selected second program, and the user may select “confirm” to begin multiviewing.

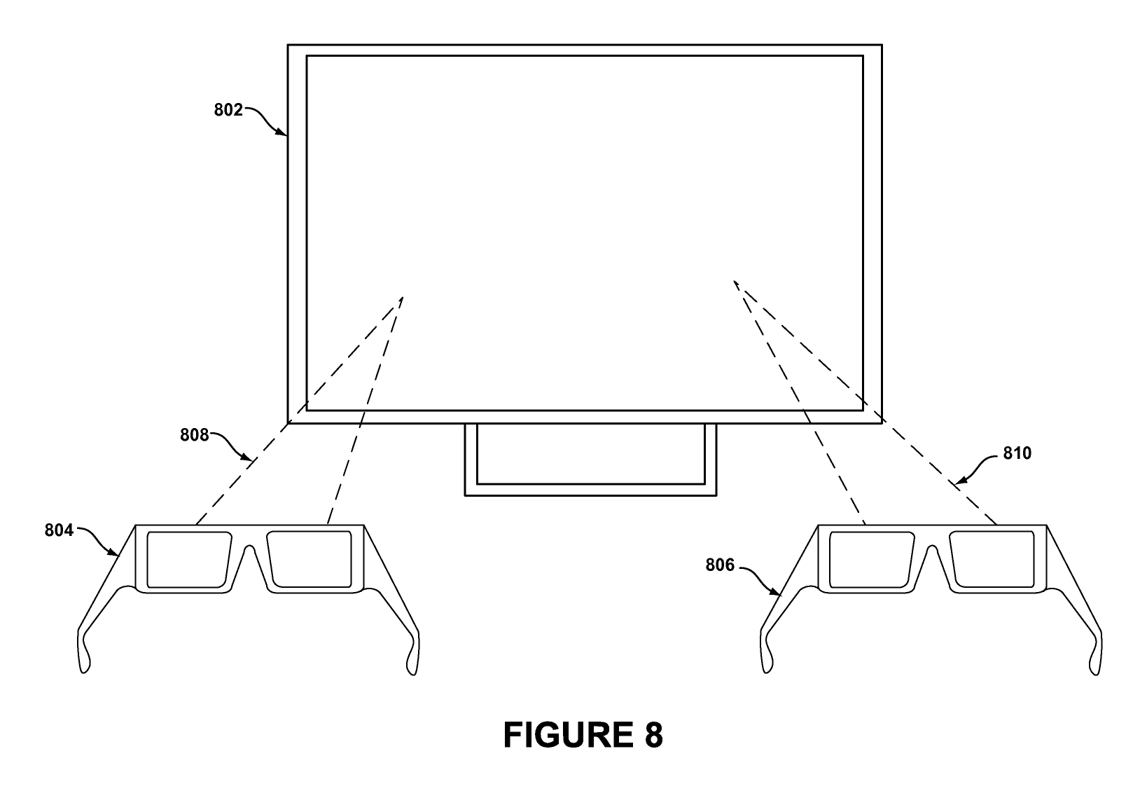

FIG. 8 is a pictorial diagram that illustrates an example system according to an example embodiment. As shown in FIG. 8, the system may include a graphic display 802, a first pair of glasses 804, and a second pair of glasses 806. To begin multiviewing, a user may select the software application as described above in a menu on the graphic display. Once selected, the application may be launched and the user may be presented with a first media signal displayable to present an option to select a first program for multiviewing. The user may select the first program, and the computing device may responsively generate the first video output signal. Subsequently, the user may be presented with a second media signal displayable to present an option to select a second program for multiviewing. The user may select the second program, and the computing device may responsively generate the second video output signal.

The computing device may then provide for display the first video output signal and the second video output signal simultaneously on the graphic display 802. In the dual polarization example discussed above, the first video output signal may be displayed via emitted light having a first polarization direction, while the second video output signal may be displayed via emitted light having a second polarization direction. The computing device may further transmit a first audio transport stream comprising audio content associated with the first program to one or more headphones of the first pair of glasses 804. The first pair of glasses 804 may be polarized, so as to pass emitted light having the first polarization direction 808, and block emitted light having the second polarization direction 810. As such, a user wearing the first pair of polarized glasses 804 may watch and listen to the first program without seeing or hearing the second program. In addition, the computing device may transmit a second audio transport stream comprising audio content associated with the second program to one or more headphones of the second pair of glasses 806. The second pair of glasses 806 may be polarized, so as to pass emitted light having the second polarization direction 810, and block emitted light having the first polarization direction 808. As such, a user wearing the second pair of polarized glasses 806 may watch and listen to the second program without seeing or hearing the first program.

In the time-multiplexed example above, content of the first video output signal may be displayed at a first periodicity, and content of the second video output signal may be displayed at a second periodicity. The computing device may further transmit a first audio transport stream comprising audio content associated with the first program to one or more headphones of the first pair of glasses 804. The first pair of glasses 804 may be active shutter glasses that are configured to be transparent when the graphic display 802 displays content of the first video output signal, and opaque when the graphic display 802 displays content of the second video output signal. As such, a user wearing the first pair of glasses 804 may watch and listen to the first program without seeing or hearing the second program. In addition, the computing device may transmit a second audio transport stream comprising audio content associated with the second program to one or more headphones of the second pair of glasses 806. The second pair of glasses 806 may be active shutter glasses that are configured to be transparent when the graphic display 802 displays content of the second video output signal, and opaque when the graphic display 802 displays content of the first video output signal. As such, a user wearing the second pair of glasses 806 may watch and listen to the second program without seeing or hearing the first program.

VI. Conclusion

While the methods described herein illustrate a number of blocks that are in a sequential order, these blocks may also be performed in parallel or in a different order than those described herein. Also, the various blocks may be combined into fewer blocks, or divided into additional blocks. In addition, it should be understood that the flow diagrams show functionality and operation of possible implementations of the present embodiments, though other implementations are also possible. Moreover, each block in the flow diagrams may represent a module, a segment, or a portion of program code that includes one or more instructions executable by a processor for implementing specific logical functions or steps in the process. The program code may be stored on data storage.

It should be understood that arrangements described herein are for purposes of example only. As such, those skilled in the art will appreciate that other arrangements and other elements (e.g., machines, interfaces, functions, orders, groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A method operable by a computing device, comprising:
receiving a first video transport stream comprising video content associated with a first program from a first network source;
receiving a second video transport stream comprising video content associated with a second program from a second network source;
generating a first video output signal based on the first video transport stream, wherein the first video output signal is configured to be displayable on a graphic display, and wherein the first video output signal includes instructions to display content of the first video output signal via emitted light having a first polarization direction that is right-handed circularly polarized; and
generating a second video output signal based on the second video transport stream, wherein the second video output signal is configured to be displayable on the graphic display simultaneously with the first video output signal, and wherein the second video output signal includes instructions to display content of the second video output signal via emitted light having a second polarization direction that is left-handed circularly polarized.

2. The method of claim 1, further comprising: providing for display the first video output signal and the second video output signal simultaneously on the graphic display wherein the first network source is via satellite and the second network source is via broadband.

3. The method of claim 1, wherein the first polarization direction is perpendicular to the second polarization direction.

4. The method of claim 1, further comprising:
receiving a first audio transport stream comprising audio content associated with the first program; and
receiving a second audio transport stream comprising audio content associated with the second program.

5. The method of claim 4, further comprising:
transmitting the first audio transport stream to a first device via a wireless communication interface; and
transmitting the second audio transport stream to a second device via the wireless communication interface.

6. The method of claim 1, further comprising:
transmitting a first audio transport stream comprising audio content associated with the first program to one or more headphones of a first polarized glasses, wherein the first polarized glasses are configured to pass emitted light having the first polarization direction, and wherein the first polarized glasses are configured to block emitted light having the second polarization direction; and
transmitting a second audio transport stream comprising audio content associated with the second program to one or more headphones of a second polarized glasses, wherein the second polarized glasses are configured to pass emitted light having the second polarization direction, and wherein the second polarized glasses are configured to block emitted light having the first polarization direction.

7-8. (canceled)

9. The method of claim 1, wherein the computing device is a set-top box.

10. A television broadcasting system comprising:
a receiver configured to (i) receive a first video transport stream comprising video content and a first audio transport stream comprising audio content, wherein the first video transport stream and the first audio transport stream are associated with a first program, and (ii) receive a second video transport stream comprising video content and a second audio transport stream comprising audio content, wherein the second video transport stream and the second audio transport stream are associated with a second program;
a video processing system configured to (i) generate a first video output signal based on the first video transport stream, wherein the first video output signal includes instructions to display content of the first video output signal via emitted light having a first polarization direction that is right-handed circularly polarized, (ii) generate a second video output signal based on the second video transport stream, wherein the second video output signal includes instructions to display content of the second video output signal via emitted light having a second polarization direction that is left-handed circularly polarized, and (iii) transmit the first audio transport stream and the second audio transport stream to a first communications device and a second communications device; and
a display system configured to display the first video output signal and the second video output signal simultaneously on a graphic display.

11. The television broadcasting system of claim 10, wherein the first polarization direction is perpendicular to the second polarization direction.

12. The television broadcasting system of claim 10, wherein the first communications device and the second communications device are mobile phones.

13. The television broadcasting system of claim 12, further comprising an audio device that receives an audio signal from the first and second communications devices, wherein the audio device comprises wired headphones, wireless headphones, or polarized glasses with built in headphones.

14. The television broadcasting system of claim 10, further comprising a polarized glasses configured to:
pass emitted light having the first polarization direction, and block emitted light having the second polarization direction; and
receive a first audio transport stream comprising audio content associated with the first program via a wireless communication interface.

15. A non-transitory computer-readable medium having stored thereon instructions executable by a computing device to cause the computing device to perform functions comprising:
receiving a first video transport stream comprising video content associated with a first program;
generating a first video output signal based on the first video transport stream, wherein the first video output signal is configured to be displayable on a graphic display, and wherein the first video output signal includes instructions to display content of the first video output signal via emitted light having a first polarization direction that is right-handed circularly polarized; and
receiving a second video output signal based on a second video transport stream associated with a second program, wherein the second video output signal is configured to be displayable on the graphic display simultaneously with the first video output signal, wherein the second video output signal is received from a separate video processing system via a local network, and wherein the second video output signal includes instructions to display content of the second video output signal via emitted light having a second polarization direction that is left-handed circularly polarized.

16. The non-transitory computer-readable medium of claim 15, wherein the first polarization direction is perpendicular to the second polarization direction.

17. The non-transitory computer-readable medium of claim 15, wherein the functions further comprise: providing for display the first video output signal and the second video output signal simultaneously on the graphic display.

18. The non-transitory computer-readable medium of claim 16, wherein the functions further comprise:
transmitting a first audio transport stream comprising audio content associated with the first program to one or more headphones of a first polarized glasses, wherein the first polarized glasses are configured to pass emitted light having the first polarization direction, and wherein the first polarized glasses are configured to block emitted light having the second polarization direction; and
transmitting a second audio transport stream comprising audio content associated with the second program to one or more headphones of a second polarized glasses, wherein the second polarized glasses are configured to pass emitted light having the second polarization direction, and wherein the second polarized glasses are configured to block emitted light having the first polarization direction.

19-24. (canceled)
